(19) United States
(12) Patent Application Publication
(10) Pub. No.: US 2006/0000225 A1
(43) Pub. Date: Jan. 5, 2006

(54) Refrigerator and/or freezer

(76) Inventor: Erwin Locher, Ochsenhausen (DE)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/174,187

(22) Filed: Jul. 1, 2005

(30) Foreign Application Priority Data
Jul. 2, 2004 (DE) 20 2004 010 404.0

(51) Int. Cl. G05D 23/00; F25B 49/00

(52) U.S. Cl. 62/126; 236/51

(57) ABSTRACT

The invention relates to a refrigerator and/or freezer with shelf compartments and/or drawers for the storage of goods provided with transponders, wherein the shelf compartments and/or the drawers each carry a reading antenna with the reading antenna being integrated in the shelf compartment or in the drawer.

The invention relates to a refrigerator and/or freezer with shelf surfaces and/or drawers in accordance with the preamble of claim 1.

As a rule, foodstuffs are cooled for longer shelf life or are frozen for a longer period of time as goods in a refrigerator (fridge) and/or freezer in the home. In this connection, difficulties arise in keeping an overview of the best-by dates and the quantities of the foodstuffs still stored in the refrigerator/freezer. It thereby occurs that the foodstuffs stored in the fridge/freezer appliances are not consumed prior to their best-by dates or run low before new foodstuffs were able to be bought.

To enable the contents of a refrigerator and/or freezer to be utilized ideally, it has already become known to use a contact-free reading system on the basis of RFID technology, with product specific data being read out via a reading antenna and a connected reading part. These data are forwarded to a master system for further processing or visualization.

A storage management on the basis of contact-free data transmission from transponder elements attached to the good and from a reading station is described in DE 299 03 032 U and in DE 298 12 877 U. At least one reading antenna is required for this data transmission. A special antenna arrangement is described in DE 200 19 288 U which is attached to or in the appliance wall or in the appliance walls. A disadvantage of this solution is that additional production steps are necessary for the installation of the antennas. A retrofitting of non-RFID enabled fridge/freezer appliances with this technology is no longer possible with this solution.

Since RFID based systems are heavily influenced by metallic screening, the reading antenna or the reading antennas have to be attached in the interior of the refrigerator and/or freezer in order to avoid too strong an influence on the reading property by the metal housing of the appliance.

Refrigerators and freezers have already become known from DE 100 60 629 A1 and DE 100 60 156 A1 in which an antenna is arranged in the form of a planar coil in each compartment base. Further planar antennas are each arranged at the door in association with each compartment.

Solutions are known from the field of store shelves in which the reading antenna is secured to the shelf base. This solution has the disadvantage that the antenna is directly exposed to the climatic influence of the temperature and of the humidity when used in a fridge/freezer appliance and that special protective measures are therefore necessary. This solution also makes the thorough cleaning of the shelf plate more difficult. When corresponding cleaning agents are used, the antenna can easily be damaged or the antenna can be “detuned” by accelerated corrosion, which substantially impairs functionality.

The object of the invention therefore consists of further developing a generic refrigerator and/or freezer such that damage to or detuning of the reading antenna can be effectively prevented to ensure the proper function of the reading system.

The object is solved in accordance with the invention in that, in a refrigerator and/or freezer having shelf surfaces and/or drawers for the storage of goods provided with transponders, the shelf surface and/or the drawers each carry a reading antenna, with the reading antenna being integrated in the respective shelf compartment or in the drawer. Due to this integration in the shelf compartment or in the drawer, the reading antennas are insensitive to climatic conditions in the refrigerator and/or freezer, for example to temperature fluctuations and humidity changes. The reading antennas also become insensitive to cleaning agents by this integration. The cleaning of the interior space of the fridge/freezer appliance or of the shelf compartments or drawers can take place in an identical manner to a normal appliance.

Advantageous aspects of the invention result from the dependent claims following on from the main claim.

Accordingly, the reading antenna can advantageously be surrounded by the material of the shelf compartment or of the drawer. The shelf compartment can thus, for example, consist of a two-layer glass plate between whose layers the reading antenna is arranged. Alternatively, however, the reading antenna can also be cast into the shelf plate or drawer.

A further advantageous aspect of the invention consists of the electronics required for the tuning of the reading antenna being applied directly to the shelf plate. Negative influences by non-screened lead guidance of the reading antenna in the appliance are prevented by the arrangement of the tuning electronics directly on the reading antenna.

The solution in accordance with the invention is also suitable in a particularly advantageous manner for the retrofitting of fridge/freezer appliances since the RFID functionality is introduced into the appliance by replacing the commercial shelf compartment or the commercial drawer with a shelf compartment with an integrated reading antenna. No other conversion of the fridge/freezer appliance itself is necessary.

Further features, details and advantages of the invention result from an embodiment shown in the drawing. There are shown:

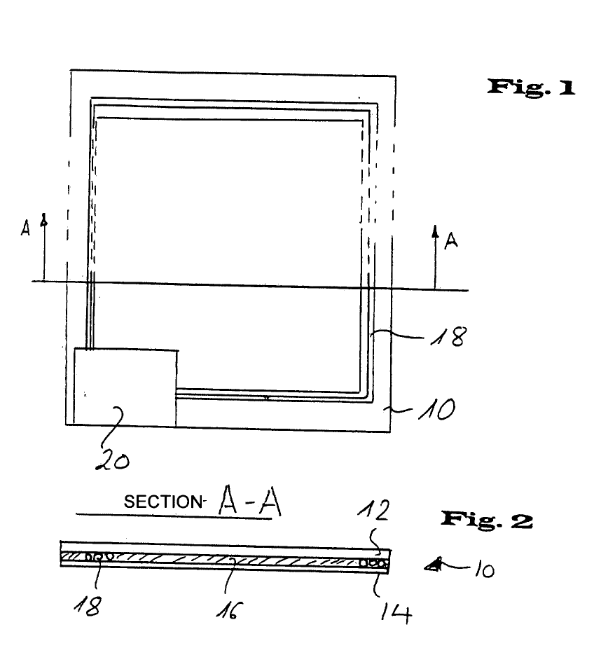

FIG. 1: a plan view of a shelf compartment in accordance with a preferred aspect of the present invention; and

FIG. 2: a section along the line A-A in FIG. 1.

In FIG. 1, a glass shelf plate 10 is shown by way of example as a typical shelf compartment of a fridge/freezer appliance. As can be seen from the sectional representation in FIG. 2, the glass plate 10 here consists of two layers 12 and 14 lying above one another. The reading antennas 8 are inserted between the layers which are adhesively bonded to one another via an adhesive layer 16, for example. The reading antennas 8 are therefore protected at all sides and do not lie open on the glass surface. They are thereby protected against external environmental influences or against damage. In the embodiment shown here, the reading antenna 18 is made in rectangular shape and runs parallel close to the outer edges of the glass shelf plate 10. Any other desired shape can naturally be realized within the framework of the invention instead of this shape of the reading antenna 18, for example in the arrangement of a loop, etc.

The tuning electronics 20 are arranged in the corner region of the glass shelf plate 10. They are therefore directly connected to the reading antenna, whereby negative influences by non-screened lead guides from the reading antenna to the appliance 20 with the contained tuning electronics are prevented.

1. A refrigerator and/or freezer with shelf compartments and/or drawers for the storage of goods provided with transponders, wherein the shelf compartments and/or the drawers each carry a reading antenna,
characterized in that
the reading antenna is integrated in the shelf compartment or in the drawer.

2. A refrigerator and/or freezer in accordance with claim 1, wherein the reading antenna is surrounded by the material of the shelf compartment or of the drawer.

3. A refrigerator and/or freezer in accordance with claim 1, wherein the shelf compartment consists of a two-layer glass plate between whose layers the reading antenna is arranged.

4. A refrigerator and/or freezer in accordance with claim 1, wherein the tuning electronics associated with the reading antenna are arranged directly on the shelf compartment or on the drawer.
